(19) United States
(12) Patent Application Publication
(10) Pub. No.: US 2021/0205715 A1
(43) Pub. Date: Jul. 8, 2021

(54) Contextual ads for esports fans

(71) Applicant: Wesley John Boudville, Perth (AU)

(72) Inventor: Wesley John Boudville, Perth (AU)

(21) Appl. No.: 16/602,967

(22) Filed: Jan. 8, 2020

(51) Int. Cl. A63F 13/86; A63F 13/61; A63F 13/35; A63F 13/79; A63F 13/56; G06Q 30/02; G06Q 50/00

(52) U.S. Cl. CPC A63F 13/86; A63F 13/61; A63F 13/35; A63F 13/79; A63F 13/56; A63F 2300/577; G06Q 50/01; G06Q 30/0209; A63F 2300/53; A63F 2300/5506; A63F 2300/5553; G06Q 30/0251

(57) ABSTRACT

Fans use a read only version of a computer game to watch a gamer. Fans wander in the game. Contextual ads are shown, based on fans' history using a search engine or social network. Gamification is used in an ad to improve response. Groups of fans form to go thru games. A fan or gamer uploads pet data to make a pet character to follow her thru the game. An improved esports experience

### REFERENCES CITED

“Apps everywhere but no unifying link” by C. Dougherty, New York Times, 5 Jan. 2015.
“Deep linking's big untapped potential” by M. Thomson, VentureBeat.com, 9 Aug. 2015.

### TECHNICAL FIELD

Esports—viewing a computer game played by another person.

### BACKGROUND

Esports rose to prominence in the last 10 years. It is the watching of someone else playing a computer game. Local esports is where the viewers are in the same physical space as the persons playing the game. This can be a sports arena where the viewers are sitting in the usual places associated with, say, a basketball game. While the gamers are sitting at tables on the floor usually occupied by the basketballers.

Remote esports is where viewers watch on their computers.

### BRIEF DESCRIPTION OF THE DRAWINGS

FIG. 1 shows a gamer, a fan and a native fan.

FIG. 2 shows a choice of logins from existing accounts.

FIG. 3 shows fans and servers interacting with the game.

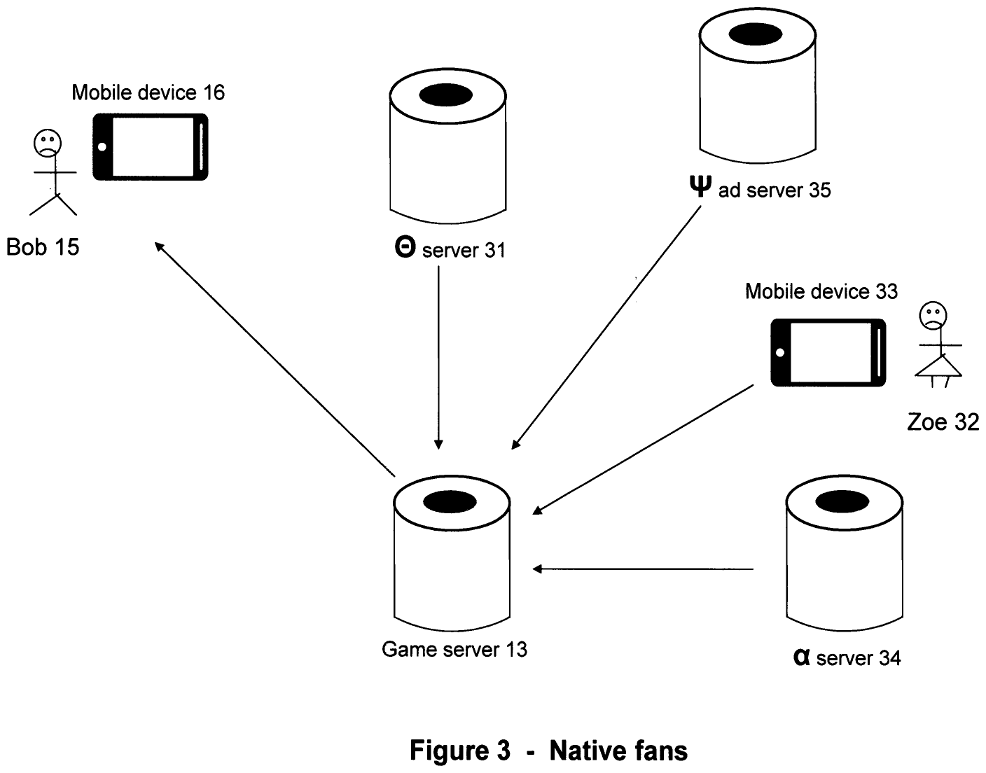

FIG. 4 shows a map of the game and a path.

FIG. 5 shows a location engine for an ad.

FIG. 6 shows a dialog window to add a pet.

FIG. 7 shows a game server making a game pet.

FIG. 8 shows ad gamification for restaurants, in a game.

FIG. 9 shows ad gamification for movies, in a game.

FIG. 10 shows groups of fans and games they can visit.

FIG. 11 shows places to visit when the gamer stops playing.

FIG. 12 lets fans follow the remaining gamer.

### DETAILED DESCRIPTION OF THE PREFERRED EMBODIMENT

What we claim as new and desire to secure is set forth in the following.

In this submission, the term phone means a mobile phone. It includes the case of using the device known as a smartphone. More broadly, we will often describe a person using a phone. This can be extended to the use of other types of mobile electronic devices or wearable devices. Like augmented reality (AR) and virtual reality (VR) devices, laptops, PDAs, HUDs. It can also include the use of personal computers and other desktop devices.

We use viewer, watcher and fan as equivalent terms, unless otherwise designated.

The submission has the following sections:

### 1: Introduction;

2: In-game ads;
3: Contextual ads;
4: Where to show an ad;

### 5: Moving ad;

6: Ad gamification;
7: Fans interacting with each other;
8: Groups competing;
9: Contextual ads and groups;
10: End of the game;

### 11: Audio;

12: Multiple gamers;
13: Recorded game;

### 1: Introduction;

This invention discusses remote esports. Currently the field is dominated by 2 firms, TWITCH Corp. and YOUTUBE Corp. TWITCH Corp. is owned by AMAZON Corp. and YOUTUBE Corp. by GOOGLE Corp. (aka. ALPHABET Corp.). In this invention we will use “esports” to mean “remote esports”. There are smaller competitors, like SMASHCAST Corp., AZUBU Corp., CAFFEINE Corp. and MOBCRUSH Corp.

Esports can be divided into live and recorded. Live means the viewer is watching a live game. Recorded means he is watching a recorded game. Live esports tends to be associated with TWITCH Corp. and recorded esports with YOUTUBE Corp. Though in fact the bulk of the content on TWITCH Corp.'s site is recorded.

The above firms have a common approach. Each has a website or app (usually both) that shows a choice of games. The viewer uses his computer to go to the app, say, and picks a game to watch. The game is then shown on his computer.

The gaming industry tends to refer to the firms as game viewing platforms. We conform to this usage and use “Platform”, capitalized thusly, to refer to these platforms.

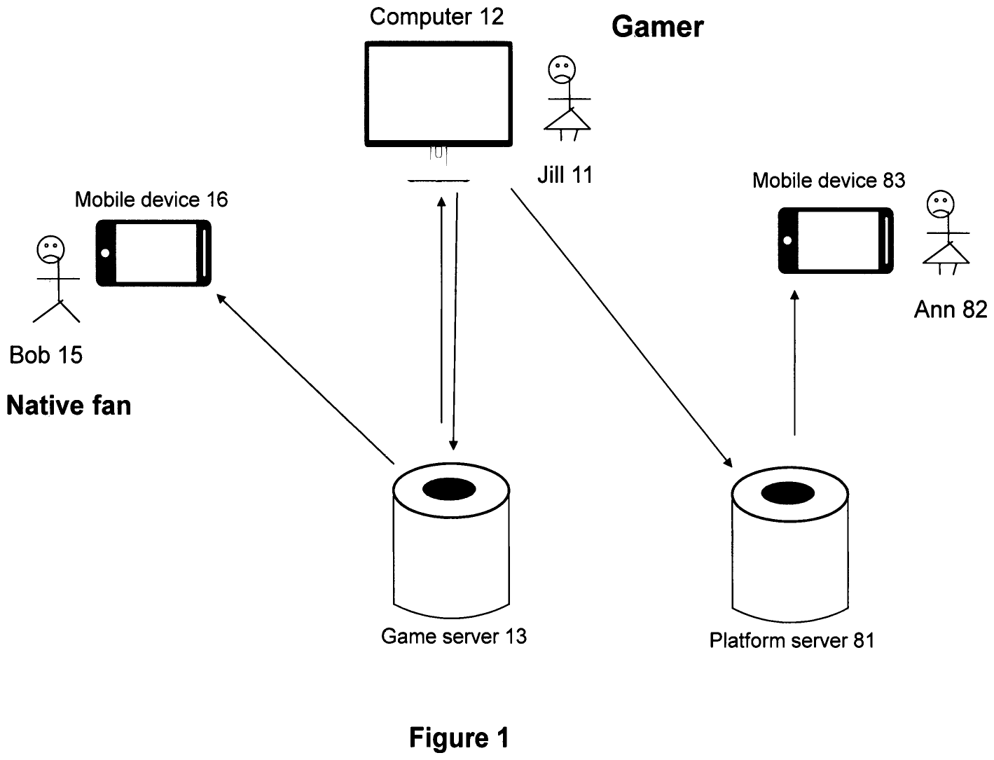

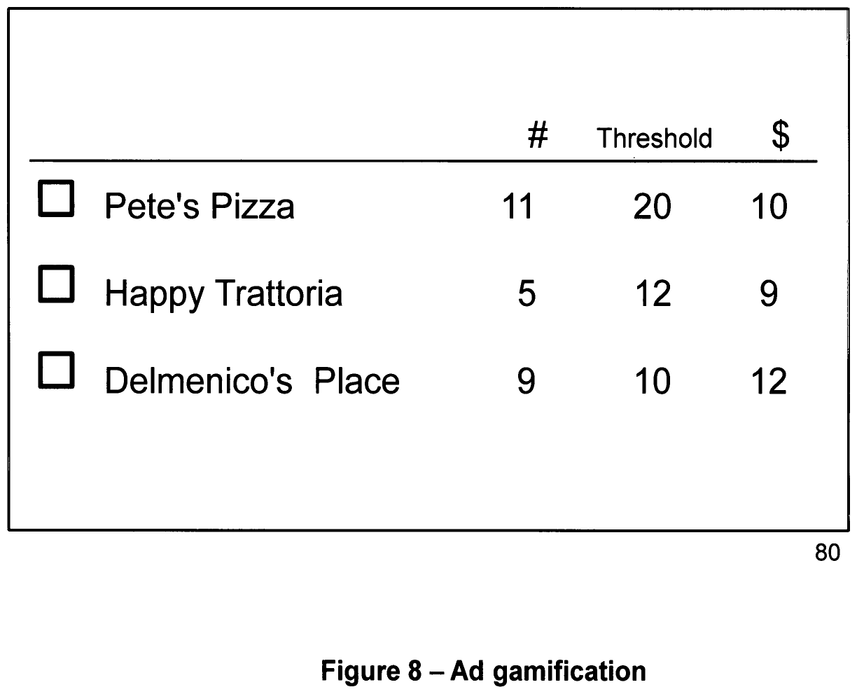

A co-pending application, “Bypass a Game Watching Platform” (U.S. Ser. No. 16/602,310 ('310)), described how a game firm and a gamer (“Jill”) can encourage fans to watch her on a read only version of the game, instead of using a Platform. See FIG. 1, which is FIG. 8 of '310. Jill 11 is the gamer. She plays her game on Computer 12. The game talks to its game server 13. Jill also has a program on her computer that relays images from her game to Platform server 81. The latter broadcasts it to fans, like Ann 82, who is using her mobile device to watch Jill.

Jill's Computer 12 is shown as a desktop machine. This is typically true of gamers, but is not limiting. She might be using a laptop or a smartphone to play. Ann is shown as having a mobile phone. Mostly because she is likely to be carrying this at many times. On Ann's phone is an app made by the Platform, which gets a feed from Platform server 81. Or Ann might be watching via the Platform's website, so her phone is running a mobile browser that shows a webpage of the Platform. We consider that Platform server 81 encompasses both a server for the Platform app and a web server for the Platform's website.

FIG. 1 shows fan Bob 15, with mobile device 16. His device has a read only version of the game, which talks to game server 13. We call him a “Native fan” because he uses an instance of the game to watch another instance of the game. The rest of this submission concerns mostly native fans. Sometimes, we shall refer to these as simply fan or fans, when the context of “native” is clear.

More generally, the native fans might be running another program, written by the game firm, and served by the game server. This program lets the fans watch the gamer, as well as move independently of the gamer thru the game world.

### 2: In-Game Ads;

Bob can be considered to be using a read only version of the game. “Read only” means that he cannot control crucial aspects of Jill's instance of the game. He cannot fire her rifle, he cannot throw her spears, he cannot quaff her magic potions. If Jill is a well known gamer, she might have many fans. Many Anns watch via the Platform and many Bobs, use read only instances.

This application assumes FIG. 1 as a starting point. In other words, how Bob was recruited to watch via the read only game is deliberately left outside the remit. '310 described mechanisms that involved a linket and deep links. The present application is not limited to those. Instead, any means of the game firm promulgating the read only games to fans like Bob can be used.

Suppose Bob and other native fans are come across a virtual object when they roam the game landscape. Imagine it is a sword. All the native fans see it. If Bob picks it up, he might be able to use it in a future instance of the game, when he is a gamer, not a fan. But in the current game, each native fan sees his own copy of the object. So if Linda is a native fan, whether Bob picks up his instance of the sword is irrelevant. In general, all the fans might be invisible to each other. Linda can decide to pick up the sword whether or not other fans do so.

So suppose in FIG. 1 there are 100 native fans. All of them see a sword. And from 0 to 100 swords can be picked up. This is a decisive difference vis a vis a game watching Platform. The Platform is broadcasting 1 image of the game, relayed from either the gamer or from 1 native fan. Suppose there are 200 fans of Jill watching her on the Platform. Only at most 1 is a native fan. Only at most 1 sword can be picked up. None of the 200 Platform fans can do this action. They are not logged into the game. At most they are logged into the Platform. (The Platform could let some visitors watch the game without being logged in.)

'310 described where the items seen by the native fans were different instances of the same item. And where the items were to be used in future instances of the game.

Another possibility is where the items are ads for real world items, to be used outside the game. Imagine an ad for, say, a cheeseburger, offered by a fast food chain. A native fan can “pick” it up. By pick, we mean any action allowed in the read only game that lets Bob claim it. The ad could be depicted as, say, a scroll lying on a table, if the game has some fantasy or medieval theme. Or the ad might be in a cylindrical celluloid film capsule in a WW2 spy game.

Bob's instance of the game lets him go up to it and do some action or command to possess it. He gets a digital coupon which he can take on his phone to his local burger joint and present on his phone screen, to be redeemed.

Suppose this virtual item cannot be seen by the gamer. This lets the gameplay carry on, without being “compromised” by ads. Also, it lets the game firm sell ad space to advertisers. These in-game ads differ from those already present in some games. Often they are implemented as, say, billboards or neon signage in games that show an urban environment. These ads are visible to all—to the gamer and to fans. They do build brand awareness. But to the gamer, there could be low efficacy if she focuses on playing the game. Especially if the game is a “twitch” (reflex shooter) game. There might be greater efficacy for the fans, given this.

### 3: Contextual Ads;

The method of the previous section can be extended. Consider contextual ads. These arose famously in the case of GOOGLE Corp.'s website. There were some 14 search engine firms prior to GOOGLE. In those, typically suppose one searched for “dog”. The resulting webpage would have (not very well chosen) organic (free) results, and paid ads on the right hand side. But the latter might be, say, an ad for used cars, an ad for fast food and an ad for shoes. In general, there was no correlation between the ads and what was searched for. The genius of GOOGLE was to combine both an intrinsically better search with ads that were related to the search term. This is one type of contextual ad.

A second type arose with social networks, including FACEBOOK Corp. The network would parse what a user (member) wrote and did on the site. Ads would be picked for that user based on this data.

The result was that GOOGLE Corp. and FACEBOOK Corp. rose to being in the top 10 firms in the US. We take this as guidance for the following.

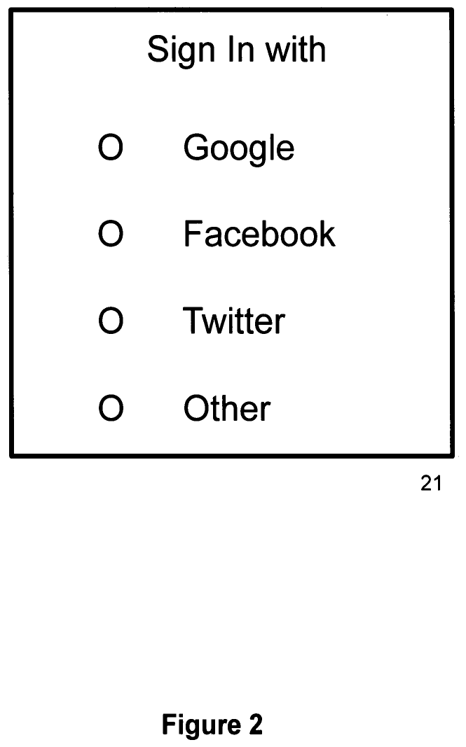

The ads shown to native fans in the previous section were not contextual. All the fans of a game who came to the same location in the game board would see the same ad. Now consider native fan Bob of FIG. 1. When he loaded the read only game onto his device and it ran, it might ask him for a sign on based on an account he had at some prominent sites. FIG. 2 gives an example of a screen he might see. It offers a choice of logging in from 3 prominent (as for 2019) sites. Of course, an actual screen might have different choices and more choices.

Assume that Bob has an account at one of those sites and picks it. This lets the game server interact with the picked site Theta server 31 and get information about him. Later, when he is in the game as a native fan and wandering thru the game world, he and other native fans nearby come across an item that is an ad. Bob might see an ad for dog food, if when he used the search engine Theta prior to the game, he searched for dog food.

Another native fan, Zoe 32, using her mobile device 33, sees an ad for a weight loss clinic, because before she watched this game, she had written on her social network page about trying to lose weight. The social network page is served from Alpha server 34. Suppose when Zoe signed into the game as a fan via FIG. 2, she picked an option that caused the game to query Alpha for her account. Now when she wanders thru the game and sees an ad, it might be served from an ad network run by Alpha.

These 2 examples are where the fan's choice of account in FIG. 2 refers to a server that then provides ads to the game server, to be put in front of the fan.

Conversely, the ads could come for a server Psi 35, separate from any server associated with the firms in FIG. 2. Psi might not have any data, or little data, on the fans. It might just be a “pure” ad server. The game server might ask Psi for an ad to show Zoe. The game server sends Psi a series of tokens, where these tokens might be key words or phrases associated with Zoe's activity on Alpha. More broadly, there might be an API between the game server and Alpha or Theta, to let the game server get the tokens.

The getting of the tokens does not have to be done each time the game server wants to show an ad to a fan. For reasons of optimization, the game server might get these for Bob at a time or times of its choosing. For example, it might do this only once for Bob, by assuming that this should suffice for him during his entire interaction with the game.

When might the game server ask for tokens for Bob? It could do this as a time when Bob is not near any place where the game plans to show an ad. This can allow for any delays in the game getting the tokens from a third party server, like a search engine.

Another case is when the game recognizes that Bob has been a previous native fan or gamer, and has cached tokens it got for him at earlier times. So in the current interaction, it uses those tokens. This assumes that his behavior or preferences have not changed, which the game might be willing to do. In part to reduce the cost of asking the third party servers. Or if it has queried for Bob for several of his earlier interactions, and seen that his tokens have not changed much if any between those interactions. That is, Bob has stable preferences.

The cost of asking for tokens from a third party server might be an actual financial cost. That server might require a payment as part of its business. The cost could also be a time and bandwidth cost of asking and waiting for a reply.

Psi could be a separate ad network. One variant is where Psi is part of the game firm.

Using contextual ads greatly increases the chance that these are seen and used.

As a matter of terminology, note that “read only” to describe the app used by native fans is an approximate descriptor and not literal. There are non-trivial actions that the fan can take in the game. As shown in the examples above. But overall, the “read only” aspect is essentially true, insofar as this describes how a native fan cannot typically interact with the gamer as she plays the game. This specifically exempts messaging and donations (“tip jar”) interactions between gamer and fans. These are well known and implemented in the prior art.

By customizing the ads to the native fans, we expect a higher efficacy. Whether measured as a percentage of fans who pick an ad, or downstream, when such ads are redeemed in the real world. This can translate into greater revenue for the game. And for the gamer, which is the person attracting the fans.

Note that when Bob picks an ad, that this pick may go to the game server, which would then communicate with the appropriate ad server. The game server can make its own data about Bob's choices. And about his non-choices, when he sees an ad but does not pick it. Over time, over all the native fans, this lets the game firm build its own database of its fans and their preferences.

The alternative to the steps in the previous paragraph is where the game sever gets an ad from an external source, like a social network or search engine. And where the ad, if clicked/picked by the fan, causes a network connection to the external source, instead of to the game server. In this case, the game server relies on the veracity of the external source to credit the game server if a transaction happens.

### 4: Where to Show an Ad;

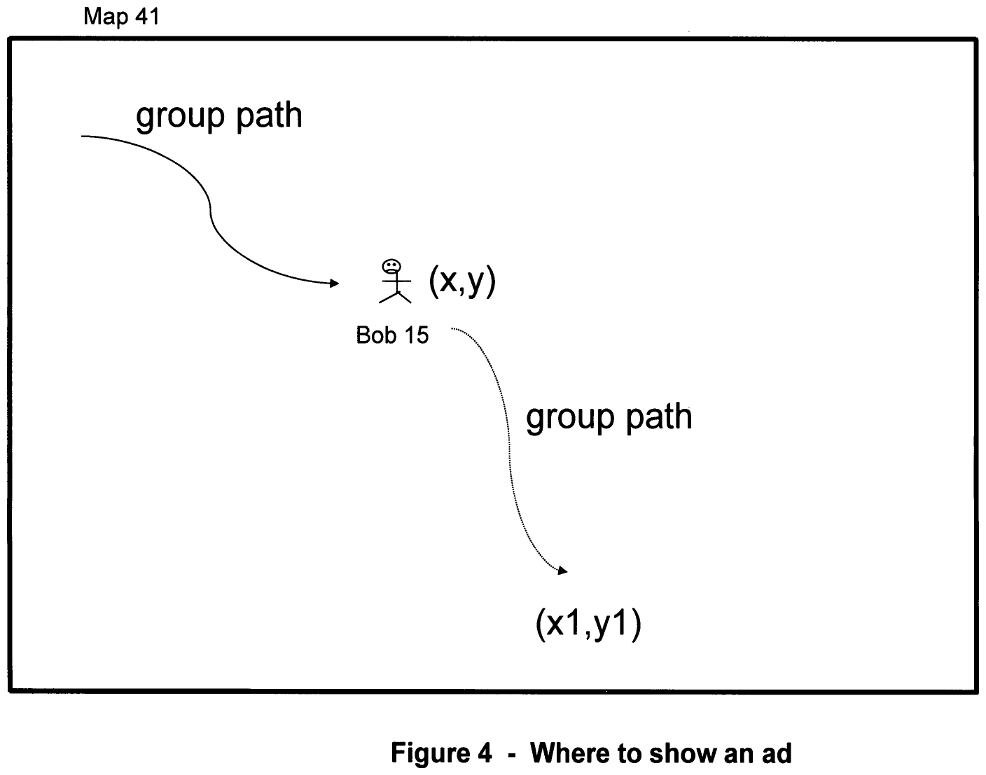

FIG. 4 shows map 41 of the game area. It shows Bob 15 wandering thru the area, and where he is currently at location (x,y). Previously in this submission and in '310, we described how native fans could wander thru the game area. One case is where individual fans can pick their own paths. The other extreme is where fans move in groups, each group led by a tour guide. Perhaps to reduce the computational load if there are many fans, the game might suggest or require movement in groups. A group might have all the fans in it being at the same point and that point moving. And that the fans see what the guide sees and shows on her screen. This reduces the need for the game to compute a unique set of pictures or video for each fan.

Earlier, we spoke of contextual ads, where a “context” was used to help find an ad (hopefully) relevant to the fan. This section expands context to also mean a location within the game area to show that ad.

Consider a group that contains our example fan Bob. The Platform could respond competitively to the game's use of a read only version by embedding an employee in the group. He pretends to be a regular native fan. But he has on his device a Platform program that will relay a copy of his read only screen to the Platform server, which broadcasts it like the other regular games on the Platform.

Thus the Platform tries to show what the group sees.

If the group reaches a place where an ad is to be shown, then the ad can be customized for some or all members of the group. This can be taken further. The game can show an ad to Bob at a place (x,y) in FIG. 4, where it does not show ads to others in the group. Or at (x,y) it shows ads to some members but others in the group will not see ads.

The game can pick (x,y) by various means. One is random. As the group moves on its path, the game randomly picks an (x,y). Here it shows an ad to Bob. The contents of the ad could be customized to Bob's interests. If Bob were to pick it, this can make a timeout for him. During whatever amount of time he spends interacting with the ad, he can remain at (x,y), even if the group moves on. After his interaction ends, then he reappears at the current location of the group, shown as (x1,y1) in FIG. 4. Or the game might show a sped up journey along the path the group took, until he gets to its current location. The images along the sped up path would have already been computed by the game and temporarily stored in memory, for this purpose (or others). So the computational load is minimized.

Another way to pick (x,y) is if it corresponds to a type of location favored by people with interests similar to Bob. Suppose (x,y) is in a graveyard with tombstones. A particularly ornate tombstone or associated statuary could be chosen to show an ad on or near, if Bob's interests include architecture or religion. The game could use a location engine. This might use his tokens as input. And perhaps his history in other games run by the game server. Or the history of other fans.

Another example is where (x, y) is in front of a virtual restaurant. And the game knows that Bob has previously read and, better yet, written reviews of real restaurants from the social network that he uses. The game shows an ad for a real restaurant. It might even pick an ad for a restaurant of the same type as the virtual restaurant at (x,y). If the latter is Italian and the game server has an ad for an Italian restaurant in its ad inventory, it might show the ad to Bob.

Here we spoke of an ad inventory. This can be held at the game server itself. Or it might be furnished by the social network that Bob uses. So the game server might ask the server that Bob uses, to send the game server an ad, where the game server first sends a query of (restaurant, Italian) to that server. In practice, an API could be used for this interaction between servers.

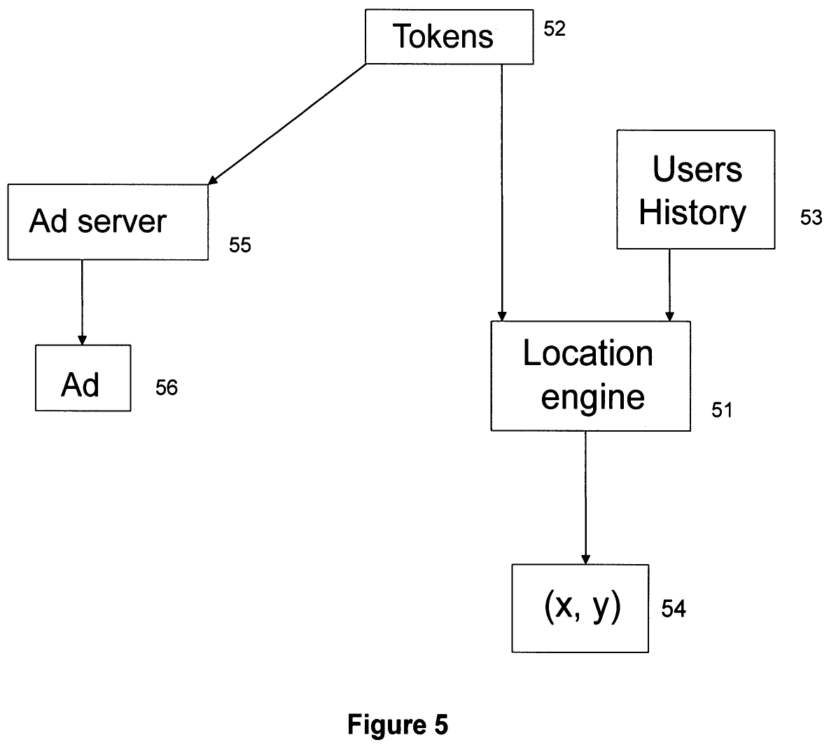

FIG. 5 shows a location engine 51 accepting inputs of tokens 52 and users' history 53 to make a location (x,y) 54. The location engine might be an engine within the overall game server, that makes the decisions described in this section.

### 5: Moving Ad;

Thus far, we considered ads fixed in place inside the game world. The ads might be “normal” signage, like a neon sign. Or perhaps shown as objects in the game, compatible with the game theme, like a scroll in a fantasy or medieval game. Another possibility is where the ad is a moving ad. We do not mean “mobile ad”, as that often refers to an ad to be shown in a mobile device. A moving ad is where the ad is on or part of or associated with a Non Player Character (NPC) or object in the game that moves. Here, the NPC can be imagined as being at (x,y) in FIG. 4. Bob meets the NPC there and as he moves along the path, it follows him.

The NPC might be an elf carrying a scroll containing the ad. The game offers some type of interaction with the elf. If Bob does this, he gets the scroll and can read the ad.

The NPC might be invisible to the gamer, to separate cleanly the fans from affecting the gameplay of the gamer herself.

We said the NPC follows Bob. Another case is where the NPC tries to induce Bob to follow it, on a temporary and different path. Different from the path that the group takes, if Bob is part of a group of fans. For example, the NPC might be a nymph, inviting him to chase her. If he catches her, he gets a medallion, in which he can read an ad.

An elaboration is where the interaction between the fan and NPC, with both moving, can be such that “follow” can mean both. Imagine an NPC being a friendly dog. One or both or the fan and NPC may end up moving away, and the other follows. In terms of a contextual ad, the game server might know or find out from the server that a fan used to login, that she may have a real dog, for example. If the server is a search engine, the fan had previously searched for dog food or dog toys. Given this, the game server could make an NPC dog, perhaps wearing a backpack or pouch carrying an ad or clue, and put that dog in front of a fan.

The choice of a dog NPC is significant. The 2 most common pets are dogs and cats. Many dog owners walk their dogs. Few cat owners do so.

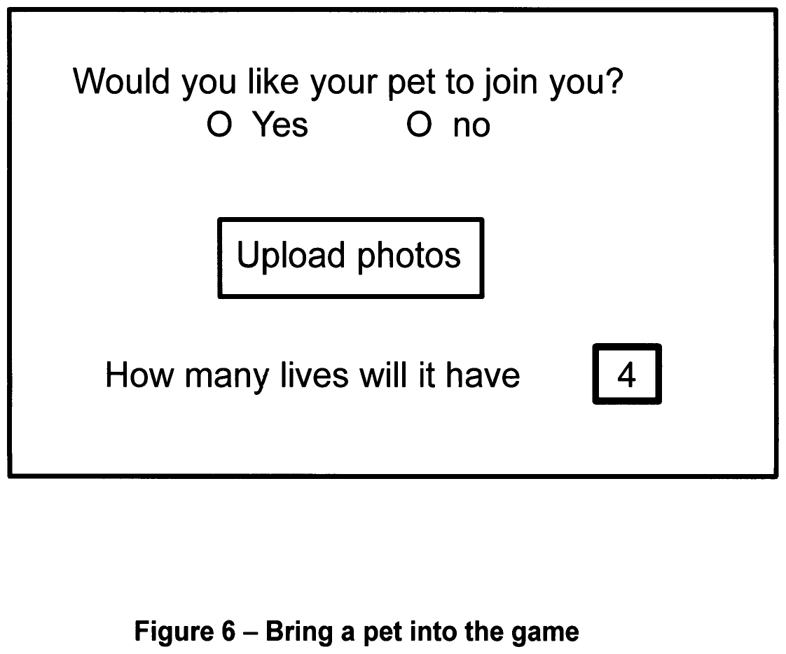

A variant is where after she logs into the game, it asks her if she would like her pet to accompany her in the game. If so, its asks her some questions. And to upload images of it. This has the advantage of bypassing third party servers. As well as providing extreme customization for her. FIG. 6 shows an example dialog window appearing when she logs in. The “upload photos” is a button that lets her upload photos of her pet. She can be in those photos. The game server takes the photos and makes a 3d skin of the pet and drapes it onto a model of the pet. All this is technically already doable in other contexts. For example, where a 3d person is recreated from 2d photos of him.

FIG. 6 also shows a “How many lives will it have” box. This is optional and can be where the pet is animated and can defend the fan. It might be killed but can live again.

FIG. 6 offers a variant. The fan need not have a pet. She uploads photos of, say, a tiger. The game server can use pattern recognition to recognize this as a tiger and to articulate it differently from a dog. So that it can climb a tree, for example. But behaviorally in the game, the tiger can be her pet, and defend her. Or if she uploads photos of an elephant, the game can let her ride it. The game can put a howdah on the elephant for her to ride in.

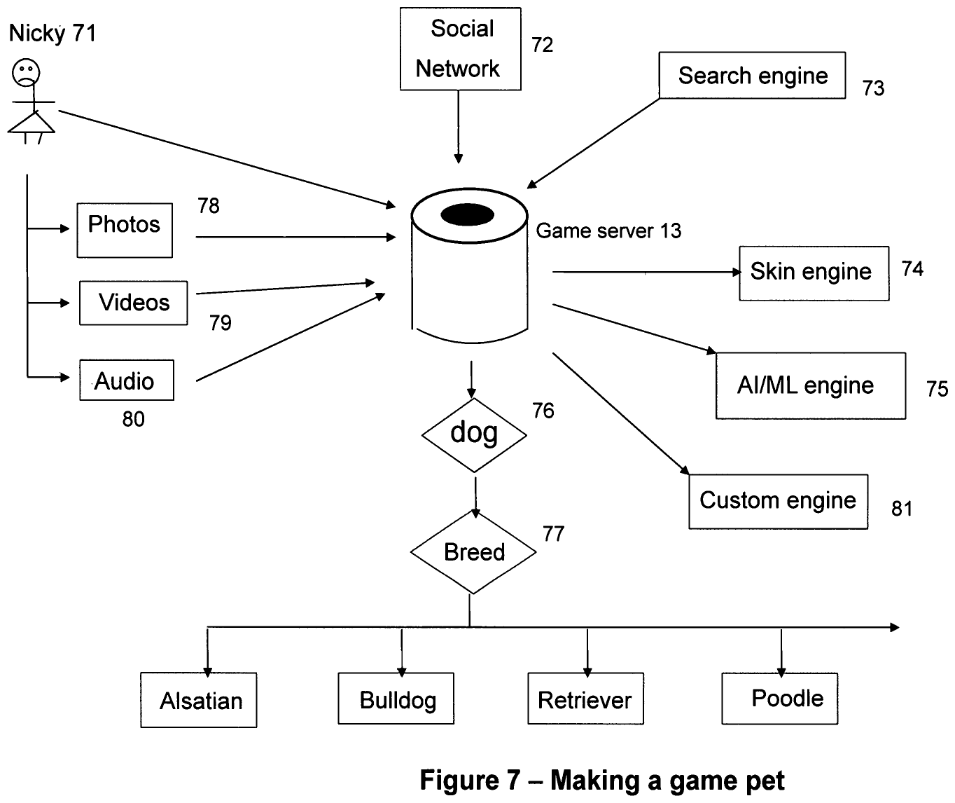

See FIG. 7. Nicky 71 is a dog owner. She can be a gamer or fan. Suppose she logged into game server 31 using her credentials in social network 72. Many people with pets show photos of the pets in their social pages. The game server might have spidered her pages when she logged in. It searches for text and images. It uses images of, say, a given brown and white and black dog to make an NPC dog approximating her pet, including fur coloration and patterning, using skin engine 74. Down to the sex of the dog, if the game server can infer this from its spidering. For example, the fan might give the dog a male name. Or some photos of the dog reveal the dog's sex.

A skin engine for a pet may be simpler than one for a human, even if the former does not currently exist. Much work has been done on human skin engines. The biggest cause for complexity was modelling the face. There are many facial muscles in the human face. More so than on pets. Humans are hardwired to recognize minor changes in a person's face. It was difficult to get human skins plausibly done. (Cf. “uncanny valley”.) Pets do not have the same expressive power in their faces.

Suppose Nicky logged in using search engine 73. The contextual history of the fan might indicate she has searched for information about golden retrievers. The NPC can be depicted as a golden retriever.

FIG. 7 has Photos 78, and Videos 79. As per FIG. 6 where these data are directly uploaded by the owner to the game server.

The game server can have engines to analyze the input photos, video and audio. Item 76 is where the game server identifies the pet as a dog. If it detects a dog, we go to item 77 which is where the server tries to id which type of dog breed. 4 breeds are shown; other breeds are possible. Each breed has data of looks, anatomy and typical behavior. A retriever is friendly. An Alsatian is aggressive. A poodle is a nuisance. Etc. Thus the broad behavior of a dog as well as the fur coloration can be used to approximate an actual pet.

We go further. Some pets have unique behaviors. The owner can use FIG. 6 to upload videos of the pet, where the pet was doing those behaviors. The game server can analyse the videos, perhaps using AI or machine learning or neural nets, as per item 75, to extract and encode the unique behaviors into the game pet. Custom engine 81 is for the deducing and use of unique behavior of the pet. Deducing mostly from the input videos and possibly photos. This might also be aided by comments from the owner. The custom engine could call upon AI/ML engine 75.

Then, especially if the game is a Virtual Reality game, the owner and pet can wander, as in real life. If the real pet is dead, these methods can let the owner have an interactive simulation with good memory associations. If the videos were taken when the pet was in good health, this can be an added attraction.

A variant is where Nicky can bring more than 1 pet into the game.

Letting the gamer or fan bring pets along can induce more gameplay and ad revenue.

Thus far, the focus was on making a simulation as accurate as possible based on a living (or once living) pet. Imagine that the data on which the simulation was based is kept in a pet database separate from the game server. The pet database can have many such pets, from different owners. Pets can be of many species. Game server 13 could let a gamer or fan access the external pet database, to bring in a pet companion for the game.

The gamer server could let a user manipulate the properties of a digital pet. For example, a cat might be spun up to be the size of a leopard or a bear.

If the player (gamer or fan) has to fight monsters, the game server can set rules for how a pet might defend her. There are well established combat parameters and methods to use these for players (human or otherwise) in gaming. These can be applied to a pet. The game can set maximum values for the pet, to prevent the player simply cranking up the strength value or hit points, for example, so that the pet can trivially win a struggle.

Note that for the owner being a fan or gamer, the owner's avatar does not need to resemble the owner in real life.

Another type of pet can be a horse. Some people have real life horses. And in historical times, horses were used as a main form of transportation. So the player (gamer or fan) might upload images or video of a horse that she will ride in the game. As earlier, these data might be of her real horse or of another person's horse.

The game might let her outfit the horse with a saddle and other items that correspond to a specific culture or historical period. For example, she might upload images of a famous destrier (war horse) of medieval times.

Another type of pet can be an elephant. These were also used as war animals. The game could let her outfit it with a howdah (a structure at the top of the elephant where the rider and passengers sit). She can be the mahout (rider).

Another type of pet can be a camel. These were used as pack and war animals. She can upload photos of video.

Another case is where the riding animal is based on actual animals, but those that were unlikely ever to be ridden. Like lions, tigers and bears. Or dinosaurs.

Another case is to upload for an imaginary creature. Like a unicorn, to be ridden as a horse.

Now consider a group of fans. The game server might infer from contextual history about several of the fans from, say, a search engine that they have accounts at, that those several fans likely owned dogs. So the game server spins up an NPC dog and puts it in front of them. The game server might even do this, lacking any specific information about the fans. It could play the odds, given that many people have dogs. The same can also be said for cats.

Suppose several fans follow or interact with the dog. They get close enough to touch the pouch. This might display the ad. One case is that it only appears on the screen of the fan who touched the pouch. Another is that it appears on all the screens of the fans nearby. This has the advantage of maximising the audience of the ad.

A variant is where the dog takes the fan or fans to a place having an ad.

For horses, elephants, camels, donkeys, mules, burros, llamas, if there is a group of fans or gamers, one scenario is where these animals are uploaded into the game. Perhaps all horses, say, or perhaps horses and mules, say. Enough to give all the players something to ride.

The possible existence of pets in the game can also be used as a game element, for both fans and gamers. For example, a gamer might be forbidden from bringing in a pet until she has achieved some level in the game, or spent a minimum time in the game. And if she can bring a pet, the game can set a maximum strength (or equivalent property). Where perhaps later, as she gains experience, she might be able to upgrade the pet's strength. Or bring in a second pet.

### 6: Ad Gamification;

Gamification refers to taking a real world task, which is not a game, and recasting it as akin to a game. With recreational type aspects. The idea is to make doing the task easier or more likely to be completed. This submission describes a game being played by a gamer and watched by fans. Ads are shown to the fans.

This section describes a different type of contextual ad. Where gamification is used to sell more items. FIG. 8 shows an ad that might appear before Bob at some place (x, y) in the game. Earlier we said a scenario where he had read and written reviews of restaurants. Now the ad shows take out (“to go”) pizzas at 3 real world places near Bob. If enough people pick an offer from a restaurant, the price per pizza falls for everyone who picked the offer. A volume discount. Item 80 is a screen that might be shown to Bob on his mobile device. For Pete's Pizza, 11 people have picked the offer. The threshold is 20 people. Currently for those 11 people the price per pizza is $10. If at least 20 people sign up, the price per pizza will fall. For simplicity this price is not shown in FIG. 8. The other 2 restaurants have similar deals.

The gamification can best be seen in the third line of FIG. 8. The Delmenico's offer has 9 people. If one other signs up, all 10 get a price per person less than the current price of $12. FIG. 8 incents people to bid in the hopes of getting a lower price.

Who are these other people who placed those orders? Some might be native fans of the game instance that Bob is in. But there is no need to restrict the buyers to be fans. Some might be native fans of other game instances currently hosted by the game server. Some might be fans of other games hosted by other game firms. Yet others could be not running any intrinsic games, but perhaps were searching for cheap nearby pizza on the network.

One merit of FIG. 8 is that it expands the audience of who can bid on an item to fans of the game. This increases the liquidity of the marketplace for volume discounts. Which can be beneficial for those already taking part and those who will take part thru being fans in the game.

The ad of FIG. 8 might persist for some time on Bob's device. This gives more time for Bob to decide to (hopefully) place an order. The ad could be encapsulated within the game instance that Bob is using. Or using deep links, the ad might appear in an ad app. The latter could have been installed, with Bob's permission, when he clicked a deep link in his game instance.

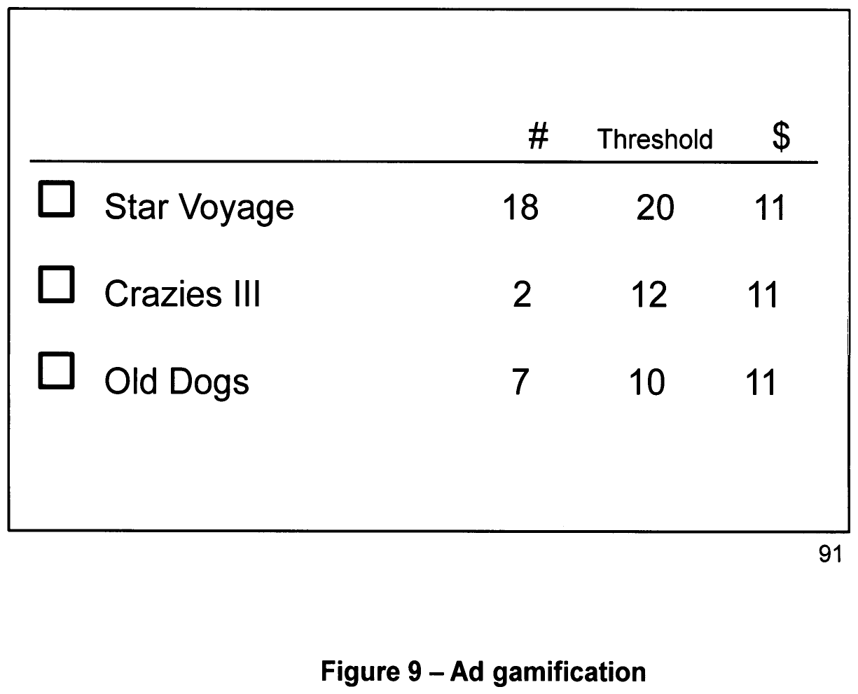

The example of FIG. 8 was for people near restaurants in the real world. FIG. 9 shows where the fans can be anywhere (at least implicitly) in a given country. The items are movies showing in theatres throughout, say, the province or country. We might imagine that the standard price is $12 at the box office. But just for buying via the ad, the price is $11. If a threshold is reached, the price falls for everyone who bid on that movie. The tickets would be virtual tickets that winners could show on their phones when going to any theatre of that theatre chain.

The ad gamification is a different type of game than the actual game in which the ad is shown.

7: Fans Interacting with Each Other;

One key facet of prior art esports is how fans can interact with each other, to some extent, while using the Platform to watch a gamer. Fan-fan interaction is very limited. Essentially it is typically via a message board, hosted at the level of the Platform app, where everybody sees the same screen of the gamer. The game server knows nothing of this because none of the fans are logged into the game.

In the current application, fans in a game instance can form groups. There might be some maximum size of a group, set perhaps by the game. The game could let fans be visible to each other. A group has the intent that its fans follow each other as they wander thru the game. But there may be instances where a group could split up, to perhaps search different paths when going thru a forest.

If fans in a group can see each other, what do they see? The game can supply pre-built avatars. A fan can pick an avatar and may have some means of customizing it. Some games could let the fan import (ie. load) a skin from outside the game. Caution is in order. If the game lets this happen, some fans might have a skin that is offensive to other fans in the group. Perhaps the skin has text that is profanity. Or the entire skin could be offputting. Think a Nazi uniform or Klansman. A game might require that imported skins or avatars be subject to approval by the game before they can be used.

The visibility of fans to each other also means that fans cannot get too close. (If fans are invisible this is largely moot.) The game can have code to prevent the visual overlapping of fans.

If fans are visible to each other, what about when 2 groups come into proximity? One answer is that only fans in the same group can see each other. If 2 groups are near, each is invisible to the other. This can improve the overall game experience for the groups. Each can pretend it is alone and exploring alone an unknown gamescape. This overcomes a common problem in real world mazes or haunted houses. If those are popular, different groups can trip over each other. It can be hard to imagine that a group is by itself.

A group's members can send messages visible only to those in the group.

A group of fans could exist outside any game instance. So members could as the group wander thru different instances and different games. This wandering on unique paths chosen by the group is a far deeper experience than having everyone just watching what the gamer sees.

The unique experiences and the persistence of a group outside any game instance can give rise to a camaraderie and sense of (virtual) community that encourages more use of games for fans to watch.

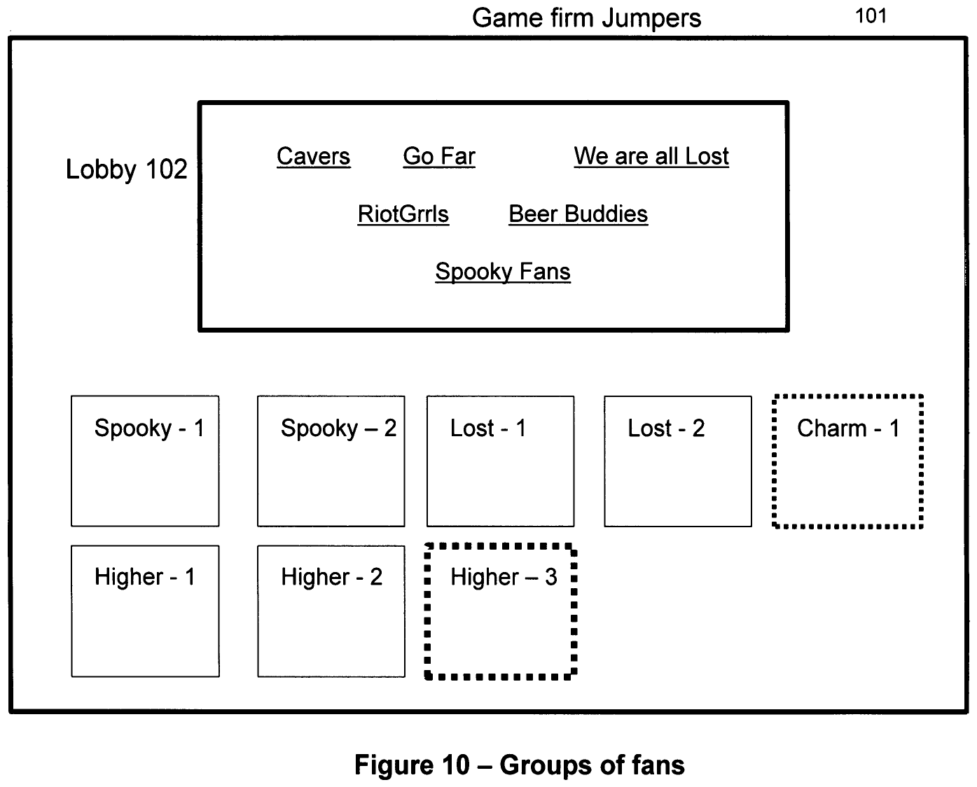

FIG. 10 shows Game firm Jumpers 101. It is assumed that Jumpers is the name of a game firm. Item 101 might be a webpage or app screen of Jumpers. A visitor who wants to be, or already is, a fan sees Lobby 102. This has a set of groups, called Cavers, So Far, We are all Lost etc. Each can be picked, as suggested by the horizontal bars under the names. Leading to a webpage or screen of more information about that group. Specifically it can show the full membership of the group. As well as which members are currently in the group to visit a game instance.

Below the Lobby is a depiction of game instances. The figure shows that the firm owns games Spooky, Lost, Charm and Higher. Each game has instances, played by different gamers. So Lost-1 is one instance of game Lost, and Lost-2 is another instance of Lost.

Note that in the Lobby is a group called Spooky Fans. This group is specifically around watching and wandering thru Spooky. But this can likely be more of a convention than an actual restriction. The game firm might let the group visit any of its game instances.

Some game instances can be live and others recorded. The figure shows Charm-1 and Higher-3 in different borders than the others. This is simply a graphical construct to indicate that those 2 instances are recorded, while the other instances are live. Of course, there are other ways to arrange the game instances, like by the number of current fans (=viewers) watching.

A visitor, Betsy, who wants to be or is a fan, to item 101 might first click on one of the groups in the Lobby. Especially if she is already a member of that group. The group can have a leader, Tim, who maybe made the group at some earlier time. Tim can have the ability to designate a time when members can assemble, to go into a game instance.

Tim might designate a game, Lost: This means that when the group has assembled, he or the group collectively can go to some instance of Lost being played. There can be a message board inside the group webpage or screen, to let Betsy and others interact.

It can be awkward for Tim to designate a specific instance of Lost, if he wants his group to see a live game. Because if he arranges a group meeting for 2 days in the future, he might not know which gamers, if any, will be playing Lost at that time. But this is both a problem and an opportunity. Imagine a (top) gamer Cheryl of Lost. She might advertise on some webpage or screen that she will be playing Lost at 2 pm US EST on 17 October. If today is 13 October, this can give enough time for Tim and other groups to schedule to watch in live play.

Cheryl has incentive to do this. It increases the chances of her getting a big audience, and hence a greater amount of ad revenue.

Informally, FIG. 8 can be imagined roughly as a mashup of MEETUP Corp. and a Platform. Current implementations of Platform have little if any group making ability. But the existence of native fans, which are fans known to the game, can Jet groups arise. And this section of the application, shows how groups can persist across different game. While MEETUP Corp. and its competitors are about how groups can form based on common interests and activities. The latter are the game instances being played, as described here.

From this vantage, FIG. 8 has an immediate extension. Imagine a webpage with a lobby for groups of fans to assemble. Below this is a set of game instances, live and recorded, made by different firms. An API would exist to let fans be known to any of those games.

### 8: Groups Competing;

Groups of fans may be able to compete with each other in a game instance. The game might include some type of scavenger hunt, where groups can pick up clues or prizes. A group might win when it amasses a certain number or “points” or some such metric of achievement.

It also means that the game can or should tighten up certain aspects to make a fair contest. When the game starts, and groups are formed, a person might not be able to join a group during the game. Or leave it, except to leave the game instance completely. This minimizes chances that someone in a group Phi was really working for another group Gamma. He garners information about Phi and then leaves and tells Gamma.

Group members might also be prevented by the game from writing to the common message board available to members who are not in groups. This (tries to) prevent a rogue member of a group writing an “innocuous” message with code words that others can decipher about the rogue's group's actions.

Whether groups can see each other depends on the game. One variant is where the groups are invisible to each other by default. But a group can find a prize that reveals information about other groups. Like the current locations of those groups, or the paths they took. Or the prizes or clues they found.

If groups can see each other, this suggests the “physical size” of the group can be an issue. Suppose there is a scavenger hunt between groups to find clues scattered thru the game world. One such clue might be blocked from view or from access by other groups if a member of a first group stations himself directly in front of the clue. This might not be acceptable to the game designers. Or, conversely, it could be an acceptable tactic for a group.

### 9: Contextual Ads and Groups;

Earlier sections discussed contextual ads. The existence of groups means that this itself can be a context. Affinity marketing is well known. Like marketing to alumni of a college or supporters of a football team. In this submission, an advertiser might direct ads, to be shown in the game, to members of a group. The ads could make explicit reference to the name of the group. An ad could also use knowledge of previous activities of the group. The game might make this accessible to advertisers via querying thru an API.

If groups compete with each other, a group might win prizes awarded by the game firm. There might be a league of groups, spanning all the games made by a game firm. Or across games made by various firms. A group's ranking in the league could also be used by advertisers.

### 10: End of the Game;

Currently (aka the prior art), when a gamer stops playing a game instance, the instance stops. If fans are watching the gamer thru a Platform, the game stops for them too. Though if perhaps an ad is being shown to (all) the fans, the fans can still respond to the ad. It does make sense that the game would stop when the gamer stops, because the fans are watching thru the vantage of the gamer.

But now when fans are known to the game and are wandering independently thru the game world, then the game can let this continue. For one, the fans may be doing tasks like looking for clues or prizes that are independent of what the gamer is doing. To the game, this is desirable. The game instance still has an audience that is more than just passively watching, as they would via a Platform. The game presumably is deriving or could derive residual revenue from the fans. It can extend the instance to achieve this.

One issue is whether the gamer would still get a cut of the ad revenue for revenue collected after she stops playing. It is up to the game firm to establish a policy. One argument from the gamer is that she brought them (in some sense) to the game instance, by virtue of her reputation as a gamer. So even though she has stopped playing, she should be entitled to some of the incoming revenue. Akin to when fans watch her recorded games.

Likely the firm gives her some percentage of that revenue.

The game might have a timer, that runs for some fixed duration after the gamer stops. This duration could be publicised prior to game play. When the timer ends, so does the instance for all the native fans. Though there can be a default that if all the fans quit prior to the end of the duration, then the game instance ends.

A variant is where the game has a fixed duration for the gamer; say 1 hour. At the end of the hour, if she is still playing, the game instance ends for her. At this point, depending on the game firm, any fans may or may not be able to keep being in the game instance. If the fans can keep active, then the game instance could have 2 durations, say 1 hour and 20 minutes. The 1 hour is for the gamer to play for maximum time. The 20 minutes is the “overtime” for the fans to keep being active.

Of the fans, one key group is those not wandering around on their own but following her. They were essentially seeing her vantage of the game. This group is not a formally defined group, like those groups earlier discussed. Rather it is a default option that can be expected to be chosen by some fans. The group is equivalent to those non-native fans currently watching the game on a Platform. The game should cater to this group also, and not just those native fans actively wandering the game at the end.

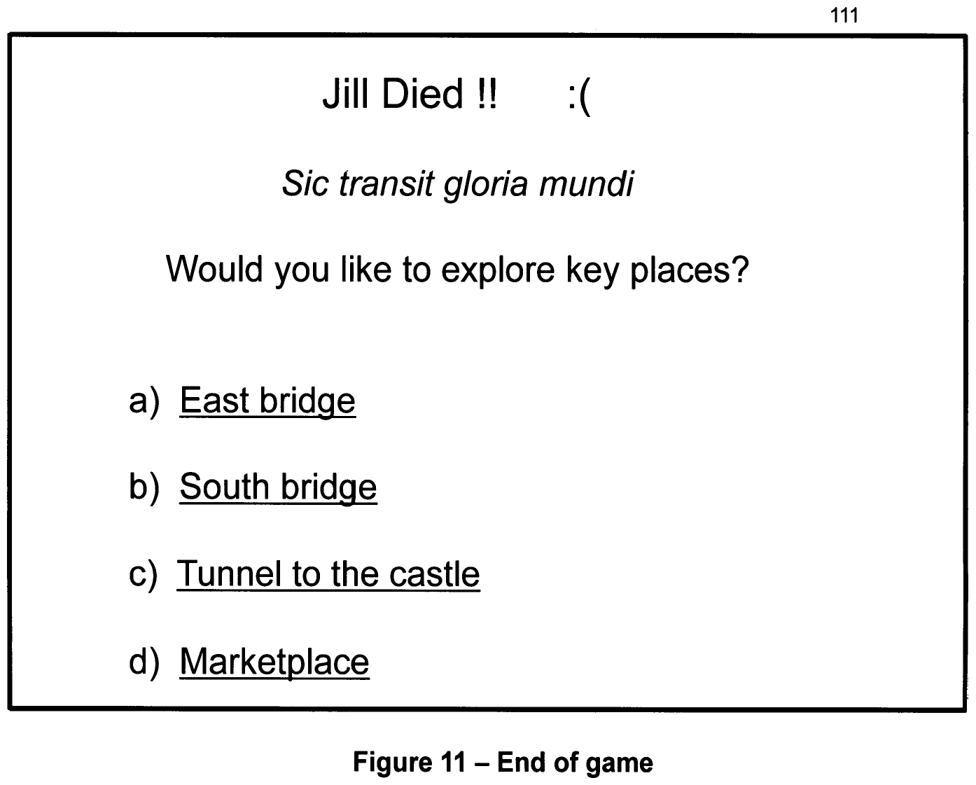

The game might show the group something like FIG. 11. Item 111 is a screen that appears to them. Jill is the gamer. We assume that she stopped playing because she died. Maybe she ran out of lives or rations, or just did not achieve the goals by the end of the game. The game shows a list of key places in the game world. These might be chosen from places that the gamer went during her play. The list can be programmatically made. For example, if the game had combat events (like many popular games), it can find the locations of those easily. These are places where the trajectory of the gamer overlapped with that of opponents.

And the game can find those areas that the gamer spent the most time in, looking for treasure perhaps. Item 111 shows the chosen places with black horizontal lines under the names. This means that each choice can be picked by the fan, and will take him directly to that place. Without the fan having to manually move thru the game world to try to find that picked place.

Item 111 shows the choices as text. In addition to this, or in place of, thumbnail images might be shown of the locations.

When the fan is taken to that picked picked, he can move around and in it, looking to satisfy any curiosity. At some point the game lets him summon the list of FIG. 11 and picked another place in the list, to be taken there immediately.

It is important for the game to cater to these fans. Some may have indeed Wanted to break off from following the gamer earlier, to explore an area interesting to them. But they wanted to follow and watch the gamer, which was the main narrative for them. It is a waste of creative effort for game designers to make original, intricate places in the game world, and not cater to these fans, who might be a potential audience to see the places. And to see any associated ads.

### 11: Audio;

We assume that a fan has access to a microphone. She can speak into it, when she is in the game instance. At her location in the game instance, there may already be sounds. Made for example by wind or animals (including fantasy animals like unicorns). The game server might cause her speech to be “played”. Perhaps she can hear her sounds in the game, after a slight delay after she speaks into the mike.

One application is if an NPC is with the fan, where the NPC is a depiction of the fan's pet, as discussed earlier. Suppose in the data uploaded to the game server about the fan and the pet is the pet's name. (A very plausible assumption.) Take the name to be Spot, for example. The game server can have speech recognition methods to recognize a command like “Spot, come here”. This command is prefaced by the fan saying “Spot”. Akin to in the real world how AMAZON Corp. has devices running the ALEXA program. Users preface their commands by saying “Alexa”.

See item 80 in FIG. 7. Simple commands can be given by a fan to a pet avatar, and the pet responds accordingly. This can simulate the fan's real life interactions with her pet.

The game server can model a generic dog as obeying a set of basic audio commands. For example, the spoken (into the microphone) “come here”, “stop barking”, “freeze”, “left”, “right” would cause the pet to do that action. Here, this might be prefaced by the name of the pet. Especially useful if the fan has several NPC pets. Thus during the game, when the fan says “Spot, come here”, the game server maps the audio into “Spot” and “come here”. The “Spot” has earlier been associated as the name of a given pet. And the spoken “come here” is converted into coding instructions to that pet, to move from its current location to near the location of the fan.

The above remarks in this section also apply to the gamer and her pet.

Another scenario is if a gamer has several pets. Perhaps these are all different instances of the same dog. The game server can let her give each dog a different name. And during the game, if she says “Rover”, this will elicit some type of response from a specific dog. This can also be used if the pets are of different species.

### 12: Multiple Gamers;

Earlier sections spoke of 1 gamer in a game instance. More generally, a game can have several gamers. The methods of this submission apply here with only minor, if any, changes.

For example, suppose a game has 2 gamers competing against each other. Each gamer has some fans following her. And there are fans wandering separately thru the game world. Suppose gamer Ann stops playing, for whatever reason. But the game goes on. (Maybe the other player wants to keep finding prizes.)

Ann's fans might see the actions of the previous section on the end of a game, to let them go to other places in the game. FIG. 11 can be altered so that another choice is added—to follow the remaining gamer.

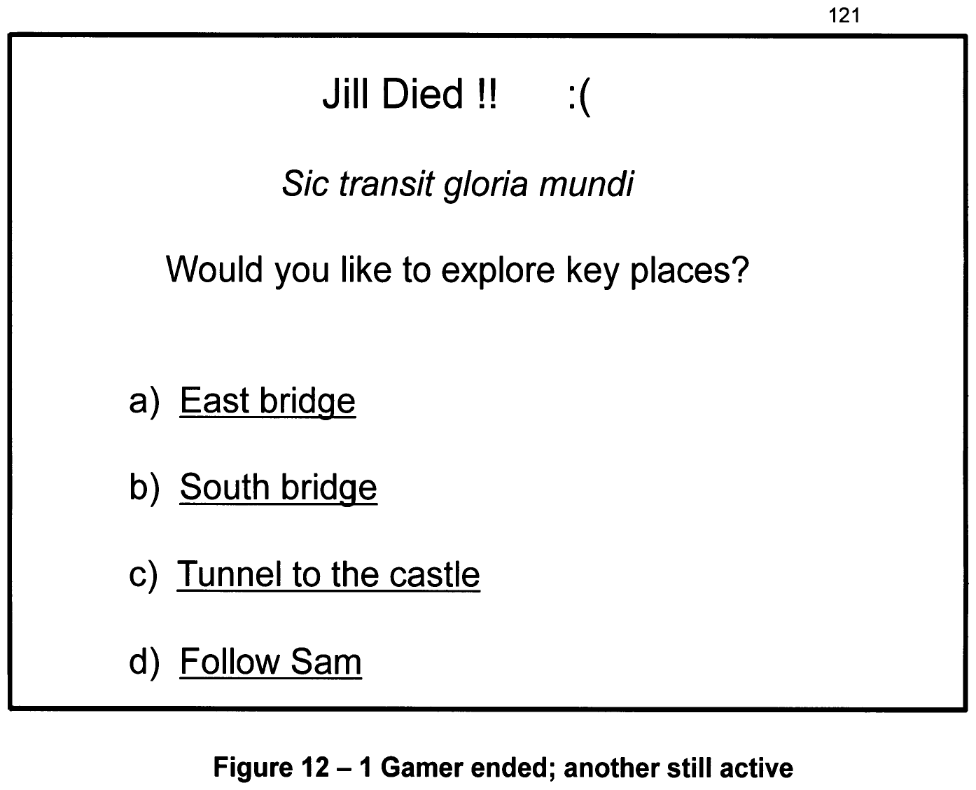

FIG. 12 shows this. Gamer Jill ended her play, but gamer Sam is still active. Choice (d) means that clicking lets the fan follow Sam.

If there are more than just Sam still playing, FIG. 12 can be generalised to let the fan pick one of the active players. If several players are active, they might be ranked various ways. Perhaps in ascending or descending order of number of fans following each gamer. Or by their game scores. Etc.

### 13: Recorded Game;

Suppose native fans are now in a recorded game. One meaning of the context of a (contextual) ad is access to a key event in the game. Suppose between time=17 minutes and time=23 minutes, and in the rectangle x=1.3 km to x=1.9 km, and y=2 km to y=3 km, there was a climatic battle. Because the game was recorded, this can be deduced by the game firm after the game was over. Manually by the firm's employees or programmatically. The firm expects that this space-time region is a crucial nexus of the game. It blocks fans from visiting it, until they watch, say, 5 minutes of ads.

Even if the ads do not use any specific knowledge of specific fans, the importance of that nexus is a context. This means that the nexus has value and so thus is access to it.

Access to that space-time region can also be modulated. For example, if a fan watches 5 minutes of ads, she gets to visit parts of it. If she watches 10 minutes of ads, she can visit more of it.

Or if she watches 5 minutes of ads, she can see all of the region, but in low resolution. Watching 10 minutes of ads gives her full resolution.

An implementation of the lockout can be as follows. Suppose a fan is in the lockout region before the start of the lockout time interval at t=17 minutes. She is watching a replay of the recording. When the time reaches 17 minutes, her location changes to some location outside the region. If she looks towards the region, she can see some opaque wall. Perhaps with a label like “forbidden” on the wall. The suggestions of the preceding paragraphs about her viewing ads might be shown on the wall. And she cannot move thru the wall.

Suppose before t=17 minutes she is outside the region and looking towards it. When t=17 minutes is reached, the view shifts to opaque.

We claim:

1: A method comprising: a game server serving a game instance being played by a gamer;
using, by the gamer, a computer to play the game instance;
using, by fans, a program to watch and interact in the game;
using, by each fan, a program instance;
serving, by the game server, the program instances;
enabling, by the game server, each fan to move independently through the game world;
showing, by the game server, ads to the fans, wherein the ads are invisible to the gamer.

2: The method of claim 1, including:
showing, by the game server, an ad to a first fan, in the program instance of the first fan;
showing, by the game server, the same ad to a second fan, in the program instance of the second fan;
enabling, by the game server, the ad to contain a digital coupon for a good or service in the real world;
enabling, by the game server, the first fan to accept the coupon;
enabling, by the game server, the second fan to decline the coupon.

3: The method of claim 1, including:
enabling, by the game server, a fan to log into a program instance using one of
(a) an account of the fan at a social network,
(b) an account of the fan at a search engine.

4: The method of claim 3, including:
obtaining, by the game server, a contextual ad for the fan, from one of
(a) a social network used by the fan to login to the game,
(b) a search engine used by the fan to login to the game;
displaying, by the game server, the ad to the fan.

5: The method of claim 4, including:
receiving, by the game server, a payment from the social network if the ad came from the social network and the fan picked it.

6: The method of claim 4, including:
receiving, by the game server, a payment from the search engine if the ad came from the search engine and the fan picked it.

7: The method of claim 1, including:
making, by the gamer server, the fans invisible to the gamer.

8: The method of claim 1, including:
receiving, by the game server, an indicator from a plurality of fans, that they wish to form a group to move through the game world;
enabling, by the game server, the fans in the group to be visible to each other;
enabling, by the game server, the fans in the group to assume visual forms (“avatars”);
enabling, by the game server, a fan in the group to customize an avatar of the fan.

9. The method of claim 8, including:
showing, by the game server, an ad at a randomly chosen location in the game world, to one or more members of the group.

10: The method of claim 9, including:
deciding, by the game server, which members to show the ad to;
wherein the decision includes using contextual data about the chosen members, and contextual data about the members not chosen to see the ads.

11: The method of claim 1, including:
showing, by the game server, a Non Player Character (NPC) to the fans;
wherein the NPC is invisible to the gamer;
wherein the NPC moves through the game world;
enabling, by the game server, a fan to interact with the NPC.

12: The method of claim 11, including:
wherein the NPC has an ad or gives access to an ad;
enabling, by the game server, the fan to view and interact with the ad.

13: The method of claim 11. including:
wherein the game server does one or more of:
(a) analyzes images or video of a pet, uploaded by the fan,
(b) spiders pages of the fan on a social network account of the fan, to extract data about the pet;
(c) searches for the fan on a search engine, to extract data about the pet;
imbuing, by the game server, an NPC with the data about the pet;
deriving, by the game server, a three dimensional depiction (“skin”) of the pet;
putting, by the game server, the skin on the NPC.

14: The method of claim 1, including:
the gamer ending activity in the game instance;
enabling, by the game server, the game instance to continue for the fans;
showing ads, by the game server, to the fans;
responding, by the game server, to ads picked by fans.

15: The method of claim 14, including:
paying, by the game server, a percentage of ad revenue to the gamer, for ads picked by fans after the end of gamer activity.

16: The method of claim 14, including:
showing, by the game server, to fans following the gamer, a list of places in the game world where the gamer visited;
receiving, by the game server, a picked place in the list, where the place was picked by a first fan;
moving, by the game server, the first fan to the picked place;
allowing, by the game server, the first fan to move in and around the picked place.

17: A method comprising: a plurality of game servers, each game server serving an instance of a game being played by gamers;
enabling, by a program, fans to login to the program;
showing, by the program, links to game instances;
wherein the links show nicknames of gamers and images from the game instances;
enabling, by the program, fans to form a group;
enabling, by the program, the group to pick and visit a game instance;
enabling, by a game server of the game instance, the group to move in the game instance, independently of a gamer in the game instance;
showing, by the game server, ads to the group.

18: The method of claim 17, where fans in the group can move independently of each other.

19: A method comprising: a game server serving a game instance being played by a gamer;
wherein the game server does one or more of:
(a) analyzes images or video of a pet uploaded by the gamer,
(b) spiders pages of the gamer on a social network account of the gamer, to extract data about the pet,
(c) searches for the gamer on a search engine, to extract data about the pet;
(d) receiving, by the game server, an audio command spoken by the gamer;
imbuing, by the game server, an NPC with the data about the pet;
deriving, by the game server, a three dimensional depiction (“skin”) of the pet;
putting, by the game server, the skin on the NPC;
enabling, by the game server, the gamer to interact with the NPC.

20: The method of claim 19, including:
receiving, by the game server, another utterance of the audio command from the gamer;
directing, by the game server, the NPC to obey the command.
